(19) United States
(12) Patent Application Publication
(10) Pub. No.: US 2025/0192697 A1
(43) Pub. Date: Jun. 12, 2025

(54) MOTOR CONTROL DEVICE AND MOTOR CONTROL METHOD

(71) Applicant: HITACHI ASTEMO, LTD., Hitachinaka-shi, Ibaraki (JP)

(72) Inventors: Shigehisa AOYAGI, Hitachinaka-shi, Ibaraki (JP); Hideki MIYAZAKI, Hitachinaka-shi, Ibaraki (JP)

(73) Assignee: HITACHI ASTEMO, LTD., Hitachinaka-shi, Ibaraki (JP)

(21) Appl. No.: 18/846,351

(22) PCT Filed: Apr. 8, 2022
(86) PCT No.: PCT/JP2022/017397

§ 371 Date: Sep. 12, 2024

(51) Int. Cl. H02M 7/5395; H02P 23/06; H02P 25/028; H02P 25/03; H02P 27/14

(52) U.S. Cl. CPC H02M 7/5395; H02P 23/06; H02P 25/028; H02P 25/03; H02P 27/14

(57) ABSTRACT

A motor control device includes: a current control unit that calculates a voltage command with respect to a d-axis and a q-axis of a motor at every predetermined calculation cycle; a carrier wave generation unit that generates a carrier wave; a carrier wave frequency adjustment unit that adjusts a frequency of the carrier wave; a phase calculation unit that calculates a voltage phase of an inverter based on a rotation position of the motor; a divided phase calculation unit that calculates a divided phase in which the voltage phase is divided for every predetermined division number of two or more; a three-phase voltage conversion unit that converts the voltage command into a three-phase voltage command based on the divided phase; and a PWM control unit that performs pulse width modulation on the three-phase voltage command using the carrier wave and generates a PWM pulse signal for controlling operation of the inverter.

### TECHNICAL FIELD

The present invention relates to a device and a method for controlling a motor.

### BACKGROUND ART

Conventionally, there is a known motor control device that controls operation of an inverter that converts direct current power into alternating-current power using a plurality of switching elements, and drives an alternating-current motor using alternating-current power output from the inverter, thereby controlling the motor. Such a motor control device is widely used in, for example, a railway vehicle, an electric vehicle, and the like.

A power loss generated in the motor control device mainly includes a switching loss of the inverter and an iron loss of the motor. The iron loss of the motor can be reduced by making the switching frequency of the inverter a radio frequency. However, when the switching frequency is made a radio frequency, a switching loss of the inverter normally increases accordingly, and therefore reduction of a power loss cannot be performed.

As a solution for the above problem, there is a known method in which a switching element having excellent characteristics at the time of radio frequency operation, such as a semiconductor switching element using silicon carbide (SiC), for example, is adopted in an inverter, and then the switching frequency is made a radio frequency. This can effectively reduce the iron loss of the motor while suppressing an increase in the switching loss in the inverter to some extent.

Regarding making the switching frequency a radio frequency, for example, the motor control device described in PTL 1 is known. The motor control device of PTL 1 includes two calculation devices, one of which performs current control calculation of the motor, and the other of which performs magnetic pole position calculation for detecting a magnetic pole position of the motor together with abnormality monitoring of the one calculation device. This achieves a high-speed, high-response motor control device using a controller such as a microcomputer.

### CITATION LIST

### Patent Literature

PTL 1: JP 2003-23800 A

### SUMMARY OF INVENTION

### Technical Problem

In the motor control device described in PTL 1, two calculation devices perform the current control calculation and the magnetic pole position calculation, respectively, and these calculation processes are executed in synchronization. Therefore, the cycle of a PWM signal output from the motor control device to the inverter for driving the switching element of the inverter coincides with the calculation cycle of the current control calculation, and the output cycle of the PWM signal cannot be made shorter than the calculation cycle of the current control calculation. Therefore, it is difficult to make the switching frequency a radio frequency.

In view of the above problems, a main object of the present invention is to make the switching frequency of an inverter a radio frequency.

### Solution to Problem

A motor control device according to the present invention is connected to an inverter that converts direct current power into three-phase alternating-current power and outputs the converted power to a motor, and controls operation of the inverter to control drive of the motor by using the inverter, the motor control device including: a current control unit that calculates a voltage command with respect to a d-axis and a q-axis of the motor at every predetermined calculation cycle; a carrier wave generation unit that generates a carrier wave; a carrier wave frequency adjustment unit that adjusts a frequency of the carrier wave; a phase calculation unit that calculates a voltage phase of the inverter based on a rotation position of the motor; a divided phase calculation unit that calculates a divided phase in which the voltage phase is divided for every predetermined division number of two or more; a three-phase voltage conversion unit that converts the voltage command into a three-phase voltage command based on the divided phase; and a PWM control unit that performs pulse width modulation on the three-phase voltage command using the carrier wave and generates a PWM pulse signal for controlling operation of the inverter.

A motor control method according to the present invention is a method of controlling operation of an inverter that converts direct current power into three-phase alternating-current power and outputs the converted power to a motor to control drive of the motor by using the inverter, the motor control method including: calculating a voltage command with respect to a d-axis and a q-axis of the motor at every predetermined calculation cycle; adjusting a frequency of the carrier wave; calculating a voltage phase of the inverter based on a rotation position of the motor; calculating the divided phase by using a value in which a calculation cycle of the voltage command is divided by a predetermined division number as a calculation cycle of a divided phase based on the voltage phase; converting the voltage command into a three-phase voltage command based on the divided phase; and generating a PWM pulse signal for controlling operation of the inverter by performing pulse width modulation on the three-phase voltage command using the carrier wave.

### Advantageous Effects of Invention

According to the present invention, the switching frequency of the inverter can be made a radio frequency.

### BRIEF DESCRIPTION OF DRAWINGS

FIG. 1 is an overall configuration diagram of a motor drive system including a motor control device according to one embodiment of the present invention.

FIG. 2 is a block diagram illustrating a functional configuration of the motor control device according to one embodiment of the present invention.

FIG. 3 is a block diagram of a divided phase calculation unit according to one embodiment of the present invention.

FIG. 4 is a view illustrating an example of a relationship between a PLL trigger and a divided phase.

FIG. 5 is a view illustrating a scene of a change of a divided phase.

FIG. 6 is a comparison diagram between a value of a three-phase voltage command obtained by conventional control when the present invention is not applied and a value of a three-phase voltage command when the present invention is applied.

FIG. 7 is a view illustrating a hardware configuration example of the motor control device.

### DESCRIPTION OF EMBODIMENTS

Hereinafter, an embodiment of the present invention will be described in detail with reference to the drawings. In the present embodiment, an application example to a motor drive system used by being mounted on an electric vehicle such as an electric car or a hybrid car will be described.

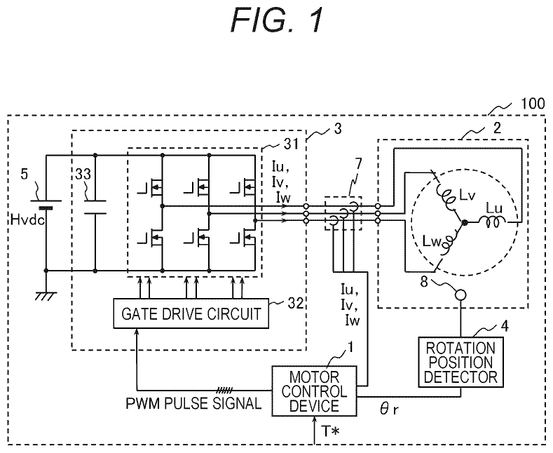

FIG. 1 is an overall configuration diagram of a motor drive system including the motor control device according to one embodiment of the present invention. In FIG. 1, a motor drive system 100 includes a motor control device 1, a permanent magnet synchronous motor (hereinafter, simply called a “motor”) 2, an inverter 3, a rotation position detector 4, and a high-voltage battery 5.

The motor control device 1 controls the operation of the inverter 3 based on a torque command T* in accordance with a target torque required from the vehicle to the motor 2, thereby generating a PWM pulse signal for controlling the drive of the motor 2. Then, the generated PWM pulse signal is output to the inverter 3. Details of the motor control device 1 will be described later.

The inverter 3 includes an inverter circuit 31, a gate drive circuit 32, and a smoothing capacitor 33. Based on the PWM pulse signal input from the motor control device 1, the gate drive circuit 32 generates and outputs, to the inverter circuit 31, a gate drive signal for controlling each switching element included in the inverter circuit 31. The inverter circuit 31 includes switching elements respectively corresponding to an upper arm and a lower arm of a U-phase, a V-phase, and a W-phase. By controlling each of these switching elements in accordance with the gate drive signal input from the gate drive circuit 32, direct current power supplied from the high-voltage battery 5 is converted into alternating-current power and output to the motor 2. The smoothing capacitor 33 smooths the direct current power supplied from the high-voltage battery 5 to the inverter circuit 31.

The motor 2 is a synchronous motor rotationally driven by alternating-current power supplied from the inverter 3, and includes a stator and a rotor. When the alternating-current power input from the inverter 3 is applied to armature coils Lu, Lv, and Lw provided in the stator, three-phase alternating-currents Iu, Iv, and Iw are conducted in the motor 2, and an armature magnetic flux is generated in each of the armature coils. When attractive force and repulsive force are generated between the armature magnetic flux of each of the armature coils and a magnet magnetic flux of the permanent magnet disposed in the rotor, torque is generated in the rotor, and the rotor is rotationally driven.

The motor 2 is attached with a rotation position sensor 8 for detecting a rotation position θr of the rotor. The rotation position detector 4 calculates the rotation position θr from an input signal of the rotation position sensor 8. The calculation result of the rotation position θr by the rotation position detector 4 is input to the motor control device 1, and is used in phase control of the alternating-current power performed by the motor control device 1 generating a PWM pulse signal in accordance with the phase of an induced voltage of the motor 2.

Here, a resolver including an iron core and a winding is more suitable for the rotation position sensor 8, but a sensor using a magnetoresistive element such as a GMR sensor or a Hall element has no problem. The rotation position detector 4 may estimate the rotation position θr not by using the input signal from the rotation position sensor 8 but by using the three-phase alternating-currents Iu, Iv, and Iw flowing through the motor 2 and three-phase alternating-current voltages Vu, Vv, and Vw applied from the inverter 3 to the motor 2.

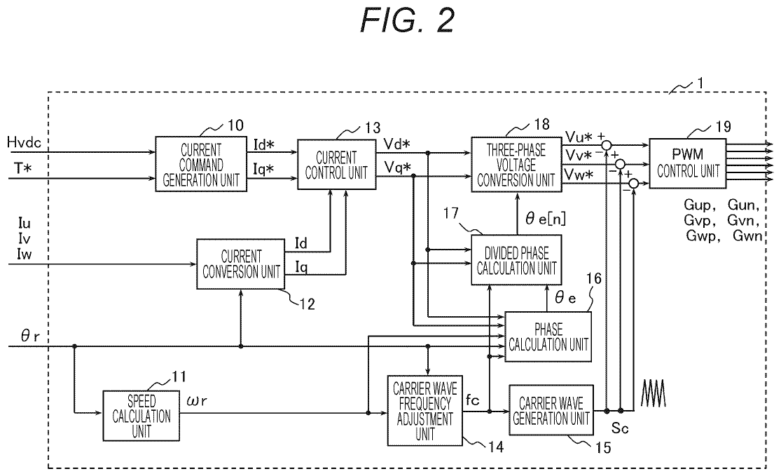

A current detection unit 7 is disposed between the inverter 3 and the motor 2. The current detection unit 7 detects the three-phase alternating-currents Iu, Iv, and Iw (U-phase alternating-current Iu, V-phase alternating-current Iv, and W-phase alternating-current Iw) that energize the motor 2. The current detection unit 7 is configured using, for example, a Hall current sensor or the like. Detection results of the three-phase alternating-currents Iu, Iv, and Iw by the current detection unit 7 are input to the motor control device 1 and used for generation of a PWM pulse signal performed by the motor control device 1. Note that while FIG. 2 illustrates an example in which the current detection unit 7 includes three current detectors, two current detectors may be provided, and the alternating-current of the remaining one phase may be calculated from the fact that the sum of the three-phase alternating-currents Iu, Iv, and Iw is zero. A pulsed direct current flowing from the high-voltage battery 5 into the inverter 3 may be detected by a shunt resistance or the like inserted between the smoothing capacitor 33 and the inverter 3, and the three-phase alternating-current Iu, Iv, and Iw may be obtained based on this direct current and the three-phase alternating-current voltages Vu, Vv, and Vw applied from the inverter 3 to the motor 2.

Next, details of the motor control device 1 will be described. FIG. 2 is a block diagram a illustrating functional configuration of the motor control device 1 according to one embodiment of the present invention. In FIG. 2, the motor control device 1 includes functional blocks of a current command generation unit 10, a speed calculation unit 11, a current conversion unit 12, a current control unit 13, a carrier wave frequency adjustment unit 14, a carrier wave generation unit 15, a phase calculation unit 16, a divided phase calculation unit 17, a three-phase voltage conversion unit 18, and a PWM control unit 19. The motor control device 1 includes, for example, a microcomputer, and can implement these functional blocks by executing a predetermined program by the microcomputer. Alternatively, some or all of these functional blocks may be implemented using a hardware circuit such as a logic IC or an FPGA.

The current command generation unit 10 calculates a d-axis current command Id* and a q-axis current command Iq* based on the torque command T* having been input and a voltage Hvdc of the high-voltage battery 5. Here, the d-axis current command Id* and the q-axis current command Iq* in accordance with the torque command T* are obtained using, for example, a preset current command map, a formula, or the like.

The speed calculation unit 11 calculates a motor rotational speed ωr representing the rotational speed (rotation number) of the motor 2 from a temporal change of the rotation position θr. The motor rotational speed ωr may be a value represented by either an angular speed (rad/s) or a rotation number (rpm). These values may be mutually converted and used.

The current conversion unit 12 performs dq conversion based on the rotation position θr obtained by the rotation position detector 4 on the three-phase alternating-currents Iu, Iv, and Iw detected by the current detection unit 7, and calculates a d-axis current value Id and a q-axis current value Iq.

Based on deviations between the d-axis current command Id* and the q-axis current command Iq* output from the current command generation unit 10 and the d-axis current value Id and the q-axis current value Iq output from the current conversion unit 12, the current control unit 13 calculates a d-axis voltage command Vd* and a q-axis voltage command Vq* in accordance with the torque command T* such that these values coincide with each other. Here, for example, by a control method such as PI control, the d-axis voltage command Vd* in accordance with the deviation between the d-axis current command Id* and the d-axis current value Id and the q-axis voltage command Vq* in accordance with the deviation between the q-axis current command Iq* and the q-axis current value Iq are obtained for each predetermined calculation cycle Tv.

The carrier wave frequency adjustment unit 14 calculates a carrier wave frequency fc representing the frequency of a carrier wave used for generation of the PWM pulse signal based on the rotation position θr obtained by the rotation position detector 4 and the rotational speed or obtained by the speed calculation unit 11. For example, the carrier wave frequency fc is calculated such that the number of carrier waves per rotation of the motor 2 becomes a predetermined number Nc of carrier waves and the relationship between the phase of the carrier waves and the rotation position θr becomes constant.

The carrier wave generation unit 15 generates a carrier wave signal (triangular wave signal) Sc based on the carrier wave frequency fc calculated by the carrier wave frequency adjustment unit 14.

The phase calculation unit 16 calculates a voltage phase (electrical angle) θe of the inverter 3 based on the rotation position θr. For example, based on the rotation position θr, the phase calculation unit 16 calculates the voltage phase θe by the following Formulas (1) to (4) using the d-axis voltage command Vd* and the q-axis voltage command Vq* calculated by the current control unit 13, the rotational speed ωr calculated by the speed calculation unit 11, and the carrier wave frequency fc calculated by the carrier wave frequency adjustment unit 14.

$$θ e = θ r + φ v + φ dqv + 0.5 \prod \qquad ( 1 )$$

$$φ v = ω r \cdot 1.5 Tc \qquad ( 2 )$$

$$Tc = 1 / fc \qquad ( 3 )$$

$$φ dqv = a tan ( {Vq}^{⋆} / {Vd}^{⋆} ) \qquad ( 4 )$$

Here, φv represents a calculation delay compensation value of a voltage phase, Tc represents a carrier wave cycle, and φdqv represents a voltage phase from the d-axis. The calculation delay compensation value φv is a value that compensates for generation of a calculation delay corresponding to 1.5 control cycles from when the rotation position detector 4 acquires the rotation position θr to when the motor control device 1 outputs the PWM pulse signal to the inverter 3. Note that in the present embodiment, 0.5π is added in the fourth term on the right side of Formula (1). Since the voltage phase calculated in the first to third terms on the right side of Formula (1) is a cos wave, this is a calculation for performing viewpoint transformation of this into a sin wave.

Here, the calculation of the voltage phase θe by the phase calculation unit 16 is preferably performed in synchronization with the calculation of the d-axis voltage command Vd* and the q-axis voltage command Vq* by the current control unit 13 described above. In this manner, the value of the voltage phase θe can be updated in accordance with the timing at which the values of the d-axis voltage command Vd* and the q-axis voltage command Vq* are updated.

The divided phase calculation unit 17 calculates a divided phase θe [n] in which the voltage phase θe calculated by the phase calculation unit 16 is divided for each predetermined division number Ne (where Ne is a positive integer of 2 or more) based on the calculation cycle Tv of the d-axis voltage command Vd* and the q-axis voltage command Vq* by the current control unit 13 and the carrier wave frequency fc. In the divided phase θe [n], n is an integer that continuously changes from 0 to Ne−1, and θe [0]=θe. Note that details of the divided phase calculation unit 17 will be described later.

Using the divided phase θe [n] calculated by the divided phase calculation unit 17, the three-phase voltage conversion unit 18 performs three-phase conversion on the d-axis voltage command Vd* and the q-axis voltage command Vq* calculated by the current control unit 13, and calculates three-phase voltage commands Vu*, Vv*, and Vw* (U-phase voltage command value Vu*, V-phase voltage command value Vv*, and W-phase voltage command value Vw*). This generates the three-phase voltage commands Vu*, Vv*, and Vw* in accordance with the torque command T*.

Using a carrier wave signal Sc output from the carrier wave generation unit 15, the PWM control unit 19 performs pulse width modulation on each of the three-phase voltage commands Vu*, Vv*, and Vw* output from the three-phase voltage conversion unit 18, and generates a PWM pulse signal for controlling the operation of the inverter 3. Specifically, based on a comparison result between the three-phase voltage commands Vu*, Vv*, and Vw* output from the three-phase voltage conversion unit 18 and the carrier wave signal Sc output from the carrier wave generation unit 15, a pulsed voltage is generated for each phase of the U-phase, the V-phase, and the W-phase. Then, a PWM pulse signal for the switching element of each phase of the inverter 3 is generated based on the pulsed voltage having been generated. At this time, PWM pulse signals Gup, Gvp, and Gwp of the upper arms of the respective phases are subjected to logical inversion to generate PWM pulse signals Gun, Gvn, and Gwn of the lower arms. The PWM pulse signal generated by the PWM control unit 19 is output from the motor control device 1 to the gate drive circuit 32 of the inverter 3, and is converted into a gate drive signal by the gate drive circuit 32. This controls on/off of each switching element of the inverter circuit 31 and adjusts the output voltage of the inverter 3.

Next, the operation of the divided phase calculation unit 17 in the motor control device 1 will be described. As described above, the divided phase calculation unit 17 calculates the divided phase θe [n] in which the voltage phase θe of the inverter 3 is divided for each predetermined division number Ne. The three-phase voltage conversion unit 18 calculates the three-phase voltage commands Vu*, Vv*, and Vw* using the divided phase θe [n], whereby the PWM control based on the three-phase voltage commands Vu*, Vv*, and Vw* in accordance with the divided phase θe [n] can be performed in a cycle shorter than the calculation cycle Tv of the d-axis voltage command Vd* and the q-axis voltage command Vq* by the current control unit 13.

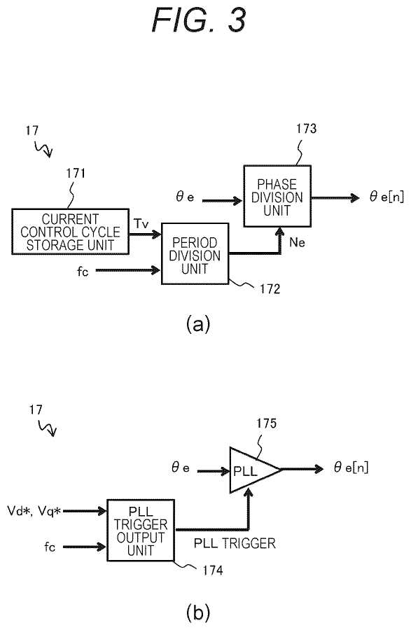

FIG. 3 is a block diagram of the divided phase calculation unit 17 according to one embodiment of the present invention. The divided phase calculation unit 17 can calculate the divided phase θe [n] based on the voltage phase θe by the configuration illustrated in either the block diagram of FIG. 3(a) or the block diagram of FIG. 3(b).

In the block diagram of FIG. 3(a), the divided phase calculation unit 17 includes functional blocks of a current control cycle storage unit 171, a period division unit 172, and a phase division unit 173.

The current control cycle storage unit 171 stores the value of the calculation cycle Tv of the d-axis voltage command Vd* and the q-axis voltage command Vq* by the current control unit 13, and outputs the value of this calculation cycle Tv to the period division unit 172.

Based on the calculation cycle Tv of the d-axis voltage command Vd* and the q-axis voltage command Vq* input from the current control cycle storage unit 171 and the carrier wave frequency fc calculated by the carrier wave frequency adjustment unit 14, the period division unit 172 determines the division number Ne used for the calculation of the divided phase θe [n]. Specifically, for example, a carrier wave cycle Tc is calculated using the above-described Formula (3) from the carrier wave frequency fc, and the division number Ne can be calculated using the following Formula (5) based on a ratio Tv/Tc of the calculation cycle Tv to the carrier wave cycle Tc. The right side of Formula (5) represents an integer value in which the fractional part of the ratio Tv/Tc is rounded down. Note that the carrier wave frequency adjustment unit 14 may use the value of the ratio Tv/Tc as the division number Ne as it is by adjusting the value of the carrier wave frequency fc such that the value of the ratio Tv/Tc becomes an integer.

$$Ne = int ( Tv / Tc ) \qquad ( 5 )$$

Based on the division number Ne calculated by the period division unit 172 and the voltage phase θe calculated by the phase calculation unit 16, the phase division unit 173 calculates the value of the divided phase θe [n] updated every cycle shorter than the calculation cycle Tv. Specifically, for example, when the phase calculation unit 16 calculates the voltage phase θe for each calculation cycle Tv same as the d-axis voltage command Vd* and the q-axis voltage command Vq*, the divided phase θe [n] can be calculated by the following Formulas (6) and (7) where the value of the voltage phase θe this time is θe1 and the value of the voltage phase θe of the last time is θe0. Here, n is an integer that continuously changes from 0 to Ne−1 as described above, and is updated every carrier wave cycle Tc.

$$θ e [ n ] = θ e 1 + n \cdot Δθ e \qquad ( 6 )$$

$$Δθ e = ( θ e 1 - θ e 0 ) / Ne \qquad ( 7 )$$

Note that Δθe obtained by Formula (7) represents an interval of the divided phase θe [n] calculated by the phase division unit 173. That is, the divided phase θe [n] can be obtained by dividing a change amount θe1−θe0 of the voltage phase θe in the calculation cycle Tv by the division number Ne to obtain the interval Δθe of the divided phase θe [n], and adding, to the voltage phase θe1 this time, a value in which this interval Δθe is multiplied by an integer.

In the block diagram of FIG. 3(b), the divided phase calculation unit 17 includes functional blocks of a PLL trigger output unit 174 and a PLL calculation unit 175.

The PLL trigger output unit 174 generates and outputs a PLL trigger for determining the output timing of the divided phase θe [n] based on the timing (hereinafter, called “voltage command timing”) at which the d-axis voltage command Vd* and the q-axis voltage command Vq* are output from the current control unit 13 and the carrier wave frequency fc calculated by the carrier wave frequency adjustment unit 14. Specifically, for example, the carrier wave cycle Tc is calculated using the above-described Formula (3) based on the carrier wave frequency fc, a pulse signal having a predetermined pulse width is generated for each carrier wave cycle Tc from the voltage command timing as a starting point, and is output as a PLL trigger. Note that also in this case, similarly to the description of the block diagram of FIG. 3(a), the carrier wave frequency adjustment unit 14 may adjust the value of the carrier wave frequency fc such that the value of the ratio Tv/Tc becomes an integer.

The PLL calculation unit 175 performs phase calculation based on the voltage phase θe calculated by the phase calculation unit 16 in accordance with the PLL trigger output from the PLL trigger output unit 174, thereby calculating the divided phase θe [n] in which the value of the voltage phase θe is divided for each division number Ne. Specifically, for example, based on the calculation result of the voltage phase θe by the phase calculation unit 16 so far, a voltage phase θe′ that continuously changes is estimated by phase calculation, and every time the PLL trigger is output, the value of the voltage phase θe′ at that time is output as the divided phase θe [n]. This can calculate the divided phase θe [n].

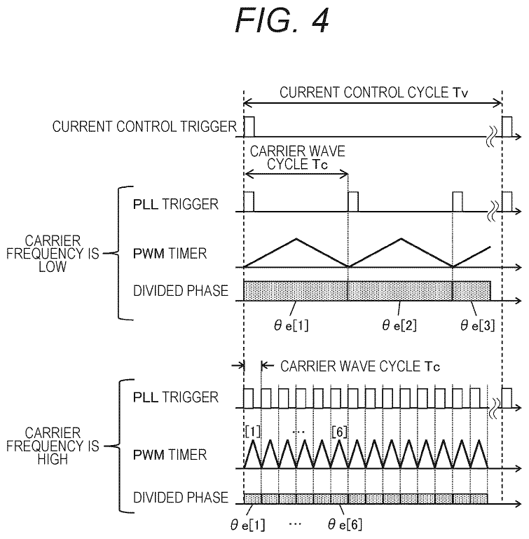

FIG. 4 is a view illustrating an example of the relationship between the PLL trigger and the divided phase θe [n] in the block diagram of FIG. 3(b). In FIG. 4, the upper stage illustrates an example of a current control trigger in accordance with the voltage command timing by the current control unit 13. The middle stage illustrates an example of the PLL trigger, a PWM timer, and the divided phase θe [n] when the carrier wave frequency fc is low, and the lower stage illustrates an example of the PLL trigger, the PWM timer, and the divided phase θe [n] when the carrier wave frequency fc is high. Note that the PWM timer corresponds to the carrier wave signal Sc generated by the carrier wave generation unit 15, and its value cyclically changes at the carrier wave frequency fc. The PWM control unit 19 can generate PWM pulse signals for the switching elements of the respective phases by comparing the value of this PWM timer with the three-phase voltage commands Vu*, Vv*, and Vw*.

As illustrated in FIG. 4, the higher the carrier wave frequency fc becomes, the more the number of PLL triggers output within the cycle (calculation cycle Tv) of the current control trigger increases. Since the division number Ne calculated by the above-described Formula (5) increases, the number of the divided phases θe [n] also increases.

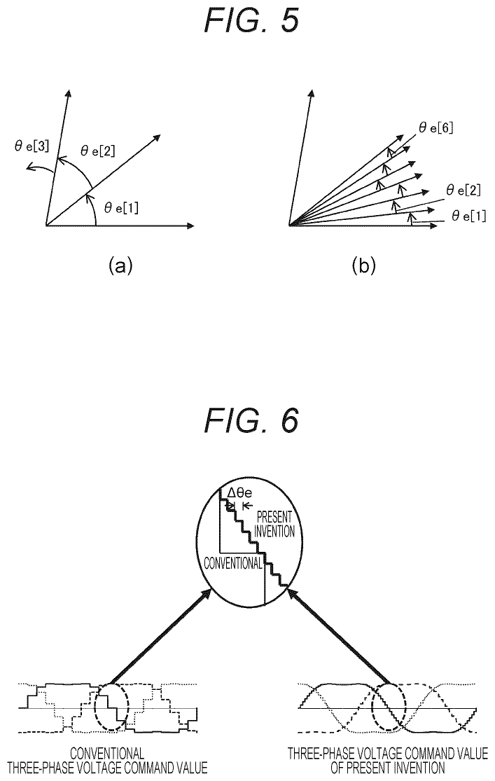

FIG. 5 is a view illustrating a scene of a change of the divided phase θe [n]. FIG. 5(a) illustrates an example of the divided phase θe [n] when the carrier wave frequency fc is low, and corresponds to the case illustrated in the middle stage of FIG. 4 described above. FIG. 5(b) illustrates an example of the divided phase θe [n] when the carrier wave frequency fc is high, and corresponds to the case illustrated in the lower stage of FIG. 4 described above.

As illustrated in FIG. 5, the higher the carrier wave frequency fc becomes, the shorter the interval of the divided phase θe [n] becomes. That is, it is possible to finely output the divided phase θe [n] regardless of the calculation cycle of the voltage phase θe. Note that the interval of the divided phases θe [n] can be expressed by the interval Δθe calculated by the above-described Formula (7).

FIG. 6 is a comparison diagram between a value of the three-phase voltage commands Vu*, Vv*, and Vw* obtained by the conventional control when the present invention is not applied and a value of the three-phase voltage commands Vu*, Vv*, and Vw* obtained by the conventional control when the present invention is applied. Here, in the conventional control not applied with the present invention, the three-phase voltage conversion unit 18 calculates the three-phase voltage commands Vu*, Vv*, and Vw* for each calculation cycle Tv using the voltage phase θe.

As illustrated in FIG. 6, application of the present invention can finely output the three-phase voltage command value as compared with the conventional control. Therefore, the switching frequency of the inverter 3 can be made a radio frequency. The interval of the three-phase voltage command values in the present invention is the interval of the divided phases θe [n], which can be expressed by the interval Δθe calculated by the above-described Formula (7) as described above.

Next, a hardware configuration of the motor control device 1 will be described below. In the motor control device 1 of the present embodiment, as described above, the divided phase calculation unit 17 performs calculation of the divided phase θe [n] (hereinafter called “divided phase calculation”) in a cycle shorter than the calculation cycle Tv of the d-axis voltage command Vd* and the q-axis voltage command Vq* by the current control unit 13. The three-phase voltage conversion unit 18 performs calculation of the three-phase voltage commands Vu*, Vv*, and Vw* (hereinafter called “current control calculation”) at the identical cycle to this divided phase calculation. Therefore, although the calculation load of the current control unit 13 does not change as compared with the conventional control not applied with the present invention, there is an increase in the calculation load due to the divided phase calculation performed by the divided phase calculation unit 17 and an increase in the calculation load due to the shortening of the calculation cycle in the current control calculation performed by the three-phase voltage conversion unit 18, and therefore the calculation load increases as a whole. The motor control device 1 needs to have a hardware configuration in consideration of such an increase in calculation load.

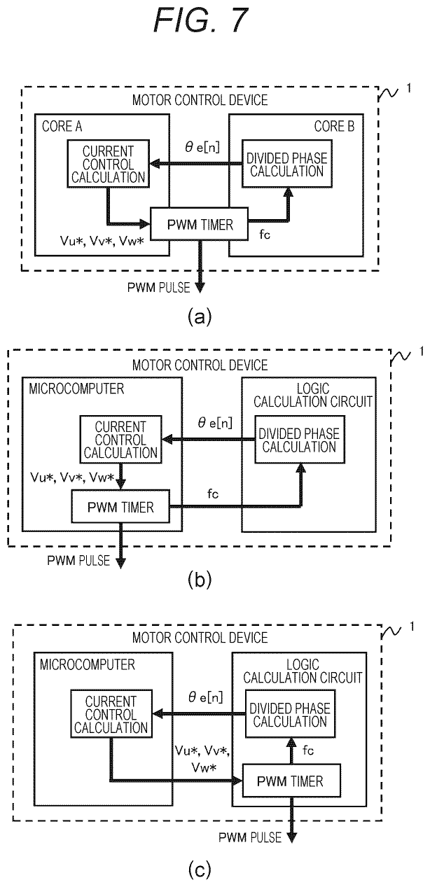

FIG. 7 is a view illustrating a hardware configuration example of the motor control device 1. By adopting any of the hardware configurations of FIGS. 7(a), 7(b), and 7(c), the motor control device 1 of the present embodiment can implement a hardware configuration that can absorb an increase in the calculation load.

FIG. 7(a) is an example of a hardware configuration in which the current control calculation and the divided phase calculation are performed by different cores in the microcomputer. In FIG. 7(a), the motor control device 1 is configured using a microcomputer including a core A and a core B. The core A performs calculation processing including the current control calculation, and the core B performs calculation processing including the divided phase calculation. Note that the processing of the PWM timer described above may be performed by either the core A or the core B, or may be performed in cooperation by both the cores. Other calculation processing performed in the motor control device 1 may be performed in either the core A or the core B.

FIG. 7(b) is an example of a hardware configuration in which the current control calculation and the processing of the PWM timer are performed by the microcomputer, and the divided phase is performed by a logic operation circuit. In FIG. 7(b), the motor control device 1 is configured by combining the microcomputer and the logic operation circuit. The microcomputer performs calculation processing including the current control calculation and processing of the PWM timer, and the logic operation circuit performs calculation processing including the divided phase calculation. Note that other calculation processing performed in the motor control device 1 may be performed by either the microcomputer or the logic operation circuit.

FIG. 7(c) illustrates an example of a hardware configuration in which the current control calculation is performed by the microcomputer, and the processing of the divided phase and the PWM timer is performed by the logic operation circuit. In FIG. 7(c), the motor control device 1 is configured by combining the microcomputer and the logic operation circuit. The microcomputer performs calculation processing including the current control calculation, and the logic operation circuit performs calculation processing including the divided phase calculation and processing of the PWM timer. Note that other calculation processing performed in the motor control device 1 may be performed by either the microcomputer or the logic operation circuit.

In the motor control device 1, by adopting any of the hardware configurations described above, the calculation unit including the divided phase calculation unit 17 and the calculation unit including the three-phase voltage conversion unit 18 can be configured using pieces of hardware different from each other. Therefore, the calculation load in the motor control device 1 can be distributed to different pieces of hardware, and an increase in the calculation load from the conventional control can be absorbed.

According to one embodiment of the present invention described above, the following operational effects are achieved.

(1) The motor control device 1 is connected to the inverter 3 that converts direct current power into three-phase alternating-current power and outputs the converted power to the motor 2, and controls operation of the inverter 3 to control drive of the motor 2 using the inverter 3. The motor control device 1 includes: the current control unit 13 that calculates voltage commands Vd* and Vq* with respect to the d-axis and the q-axis of the motor 2 at every predetermined calculation cycle; the carrier wave generation unit 15 that generates a carrier wave; the carrier wave frequency adjustment unit 14 that adjusts the frequency fc of the carrier wave; the phase calculation unit 16 that calculates the voltage phase θe of the inverter 3 based on the rotation position θr of the motor 2; the divided phase calculation unit 17 that calculates the divided phase θe [n] in which the voltage phase θe is divided for every predetermined division number Ne of two or more; the three-phase voltage conversion unit 18 that converts the voltage commands Vd* and Vq* into the three-phase voltage commands Vu*, Vv*, and Vw* based on the divided phase De [n]; and the PWM control unit 19 that performs pulse width modulation on the three-phase voltage commands Vu*, Vv*, and Vw* using the carrier wave and generates a PWM pulse signal for controlling operation of the inverter 3. This can make the switching frequency of the inverter 3 a radio frequency.

(2) Preferably, the motor control device 1 includes the first calculation unit including the three-phase voltage conversion unit 18 and the second calculation unit including the divided phase calculation unit 17, and the first calculation unit and the second calculation unit are configured using pieces of hardware different from each other. Specifically, for example, as illustrated in FIG. 7(a), it is preferable that the first calculation unit is the core A included in the microcomputer, and the second calculation unit is the core B included in the microcomputer, or as illustrated in FIGS. 7(b) and 7(c), the first calculation unit is the microcomputer, and the second calculation unit is the logical operation circuit that performs a predetermined logical operation. In this manner, the calculation load in the motor control device 1 can be distributed to different pieces of hardware, and an increase in the calculation load can be absorbed.

(3) The carrier wave frequency adjustment unit 14 may adjust the frequency fc of the carrier wave such that the value of the ratio Tv/Tc of the calculation cycle Tv of the voltage commands Vd* and Vq* to the cycle Tc of the carrier wave becomes an integer. In this manner, since the value of the ratio Tv/Tc can be used as it is as the division number Ne, the calculation load can be further reduced.

(4) As illustrated in FIG. 3(a), the divided phase calculation unit 17 can include: the period division unit 172 that determines the division number Ne by Formula (5) based on the calculation cycle Tv of the voltage commands Vd* and Vq* and the frequency fc of the carrier wave; and the phase division unit 173 that calculates the interval Δθe of the divided phase θe [n] by Formula (7) based on the change amount θe1−θe0 of the voltage phase θe in the calculation cycle Tv of the voltage commands Vd* and Vq* and the division number Ne determined by the period division unit 172, and adds, to the voltage phase θe, the value in which the interval Δθe of the divided phase θe [n] having been calculated is multiplied by an integer to calculate the divided phase θe [n] by Formula (6). Alternatively, as illustrated in FIG. 3(b), the divided phase calculation unit 17 may include: the PLL trigger output unit 174 that outputs a PLL trigger signal for each cycle Tc of the carrier wave; and the PLL calculation unit 175 that executes a PLL calculation based on the PLL trigger signal output from the PLL trigger output unit 174, updates the voltage phase θe for each cycle of the PLL trigger signal, and calculates the divided phase θe [n]. In this manner, the divided phase θe [n] can be accurately calculated with a small calculation load.

In the embodiment described above, an application example to a motor drive system mounted and used in an electric vehicle such as an electric car or a hybrid car has been described, but the present invention is not limited to this. The present invention can be applied to a motor control device used in any motor drive system as long as the motor control device is connected to an inverter having a plurality of switching elements and controls operation of this inverter to control drive of a motor using the inverter.

The present invention is not limited to the above-described embodiment, and various modifications can be made without departing from the gist of the present invention.

### REFERENCE SIGNS LIST

1 motor control device
2 motor
3 inverter
4 rotation position detector
5 high-voltage battery
7 current detection unit
8 rotation position sensor
10 current command generation unit
11 speed calculation unit
12 current conversion unit
13 current control unit
14 carrier wave frequency adjustment unit
15 carrier wave generation unit
16 phase calculation unit
17 divided phase calculation unit
18 three-phase voltage conversion unit
19 PWM control unit
31 inverter circuit
32 gate drive circuit
33 smoothing capacitor
100 motor drive system

1. A motor control device that is connected to an inverter that converts direct current power into three-phase alternating-current power and outputs the converted power to a motor, and controls operation of the inverter to control drive of the motor by using the inverter, the motor control device comprising:
a current control unit that calculates a voltage command with respect to a d-axis and a q-axis of the motor at every predetermined calculation cycle;
a carrier wave generation unit that generates a carrier wave;
a carrier wave frequency adjustment unit that adjusts a frequency of the carrier wave;
a phase calculation unit that calculates a voltage phase of the inverter based on a rotation position of the motor;
a divided phase calculation unit that calculates a divided phase in which the voltage phase is divided for every predetermined division number of two or more;
a three-phase voltage conversion unit that converts the voltage command into a three-phase voltage command based on the divided phase; and
a PWM control unit that performs pulse width modulation on the three-phase voltage command using the carrier wave and generates a PWM pulse signal for controlling operation of the inverter.

2. The motor control device according to claim 1, comprising:
a first calculation unit including the three-phase voltage conversion unit; and
a second calculation unit including the divided phase calculation unit,
wherein the first calculation unit and the second calculation unit are configured using pieces of hardware different from each other.

3. The motor control device according to claim 2, wherein
the first calculation unit is a first core included in a microcomputer, and
the second calculation unit is a second core included in the microcomputer.

4. The motor control device according to claim 2, wherein
the first calculation unit is a microcomputer, and
the second calculation unit is a logical operation circuit that performs a predetermined logical operation.

5. The motor control device according to claim 1, wherein
the carrier wave frequency adjustment unit adjusts a frequency of the carrier wave such that a value of a ratio of a calculation cycle of the voltage command to a cycle of the carrier wave is an integer.

6. The motor control device according to claim 1, wherein
the divided phase calculation unit includes
a period division unit that determines the division number based on a calculation cycle of the voltage command and a frequency of the carrier wave, and
a phase division unit that calculates an interval of the divided phase based on a change amount of the voltage phase in a calculation cycle of the voltage command and the division number determined by the period division unit, and calculates the divided phase by adding, to the voltage phase, a value in which an interval of the divided phase having been calculated is multiplied by an integer.

7. The motor control device according to claim 1, wherein
the divided phase calculation unit includes
a trigger output unit that outputs a trigger signal for each cycle of the carrier wave, and
a PLL calculation unit that executes a PLL calculation based on the trigger signal output from the trigger output unit, and calculates the divided phase by updating the voltage phase for each cycle of the trigger signal.

8. A method of controlling operation of an inverter that converts direct current power into three-phase alternating-current power and outputs the converted power to a motor to control drive of the motor by using the inverter, the motor control method comprising:
calculating a voltage command with respect to a d-axis and a q-axis of the motor at every predetermined calculation cycle;
adjusting a frequency of the carrier wave;
calculating a voltage phase of the inverter based on a rotation position of the motor;
calculating the divided phase by using a value in which a calculation cycle of the voltage command is divided by a predetermined division number as a calculation cycle of a divided phase based on the voltage phase;
converting the voltage command into a three-phase voltage command based on the divided phase; and
generating a PWM pulse signal for controlling operation of the inverter by performing pulse width modulation on the three-phase voltage command using the carrier wave.
